(19) United States
(12) Patent Application Publication
(10) Pub. No.: US 2015/0237429 A1
(43) Pub. Date: Aug. 20, 2015

(54) Microphone In Speaker Assembly

(71) Applicant: Knowles Electronics, LLC, Itasca, IL (US)

(72) Inventor: William A. Ryan, Elgin, IL (US)

(21) Appl. No.: 14/615,952

(22) Filed: Feb. 6, 2015

Related U.S. Application Data
(60) Provisional application No. 61/940,122, filed on Feb. 14, 2014.

(51) Int. Cl. H04R 1/02; H04R 1/04

(52) U.S. Cl. CPC H04R 1/02; H04R 1/04; H04R 2201/003

(57) ABSTRACT

An apparatus, the apparatus include a housing, a micro electro mechanical system (MEMS) microphone, and a speaker. The MEMS microphone is disposed within the housing. The MEMS microphone has a first diaphragm that separates a first front volume from a first back volume and is configured to receive first sound energy at the first front volume and convert the first sound energy into a first electrical signal. The first back volume is contained within the housing. The speaker is disposed within the housing and has a second diaphragm that separates a second front volume from a second back volume. The speaker is configured to receive a second electrical signal and convert the second electrical signal into second sound energy. The second back volume is contained within the housing. The first back volume and the second back volume are separated by a divider and do not overlap.

### CROSS REFERENCE TO RELATED APPLICATION

This patent claims benefit under 35 U.S.C. §119 (e) to U.S. Provisional Application No. 61/940,122 entitled “Microphone in Speaker Assembly” filed Feb. 14, 2014, the content of which is incorporated herein by reference in its entirety.

### TECHNICAL FIELD

This application relates to acoustic devices and, more specifically, to the configurations of acoustic devices including microphones and speakers.

### BACKGROUND OF THE INVENTION

Various types of acoustic devices have been used over the years. One example of an acoustic device is a microphone. Generally speaking, a microphone converts sound waves into an electrical signal. Microphones sometimes include multiple components that include micro-electro-mechanical systems (MEMS) and integrated circuits (e.g., application specific integrated circuits (ASICs)). A MEMS die typical has disposed on it a diaphragm and a back plate. Changes in sound energy move the diaphragm, which changes the capacitance involving the back plate thereby creating an electrical signal. The MEMS dies is typically disposed on a base or substrate along with the ASIC and then both are enclosed by a lid or cover.

Speakers are also used in many types of applications. Generally speaking, a speaker converts electrical signals into sound energy. For example, speakers are typically used in cellular phones and personal computers. Loud speakers are also used in various applications to present music to listeners.

In many of these applications, space is at a premium. For example, in cellular phone applications and personal computer applications it is desirable to construct a small as device as possible. Moreover, miniaturization is valued in the marketplace—the smaller the device, the more marketable the device is in many cases.

Previous approaches have attempted to conserve space in some instances, but various problems with these approaches existed. This has resulted in some user dissatisfaction with these previous approaches.

### BRIEF DESCRIPTION OF THE DRAWINGS

For a more complete understanding of the disclosure, reference should be made to the following detailed description and accompanying drawings wherein:

FIG. 1 comprises a perspective diagram of a speaker assembly with a MEMS microphone according to various embodiments of the present invention;

FIG. 2 comprises a side cut-away diagram of the speaker assembly with MEMS microphone of FIG. 1 taken along the line A-A according to various embodiments of the present invention;

FIG. 3A comprises a side view of the MEMS microphone used in the speaker assembly of FIG. 1 and FIG. 2 according to various embodiments of the present invention;

FIG. 3B comprises a top view of the MEMS microphone used in the speaker assembly of FIG. 1, FIG. 2, and FIG. 3A according to various embodiments of the present invention;

FIG. 3C comprises a bottom view of the MEMS microphone used in the speaker assembly of FIG. 1, FIG. 2, FIG. 3A, and FIG. 3B according to various embodiments of the present invention;

FIG. 3D comprises a close-up, cross-sectional view of the MEMS microphone used in the speaker assembly of FIG. 1, FIG. 2, FIGS. 3A-3C according to various embodiments of the present invention;

FIG. 4A comprises a side cut-away view of the speaker assembly with a MEMS microphone of FIG. 1, FIG. 2, and FIGS. 3A-C according to various embodiments of the present invention;

FIG. 4B comprises a top view of the speaker assembly with a MEMS microphone of FIG. 1, FIG. 2, FIGS. 3A-C, and FIG. 4A according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Speaker assemblies are provided that house both a speaker and a microphone (e.g., a microelectromechanical system (MEMS) microphone). In these approaches, the MEMS microphone includes a back volume that is also part of and enclosed by the speaker assembly. In one aspect, the speaker back volume and the microphone back volume are separated within the assembly, but are part of the same assembly. Since the speaker assembly includes both the back volume for the microphone and the back volume for the speaker, the overall size of the speaker-microphone combination is less than if there was no sharing of back volume space. This results in a smaller foot print for these elements and allows further miniaturization of systems such as cellular phones and personal computers. Furthermore, this allows total volume of the enclosure to be allocated between microphone back volume and speaker back volume to optimize performance of each of the acoustic transducers as required to best suit the design needs of the system.

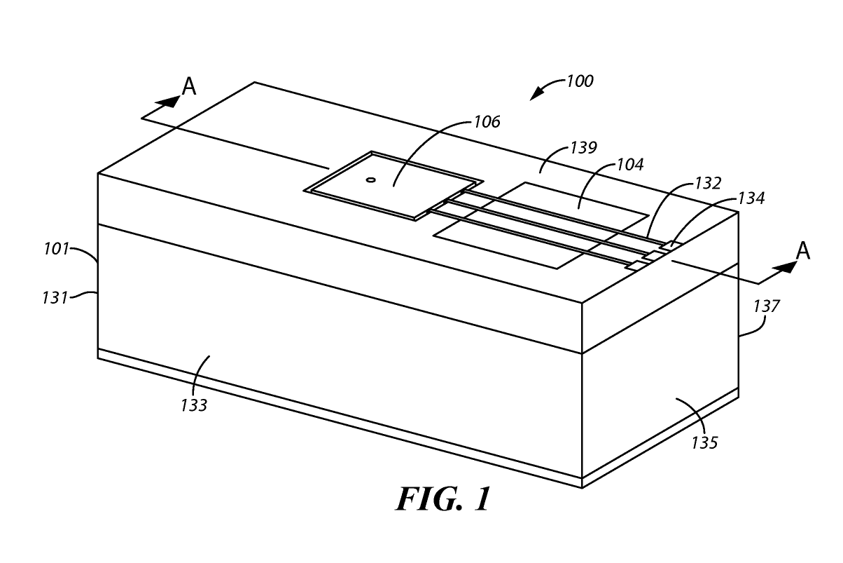

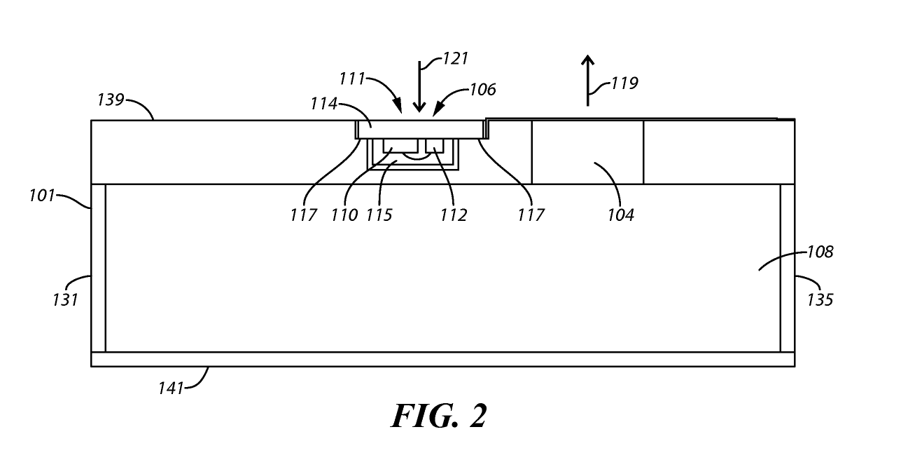

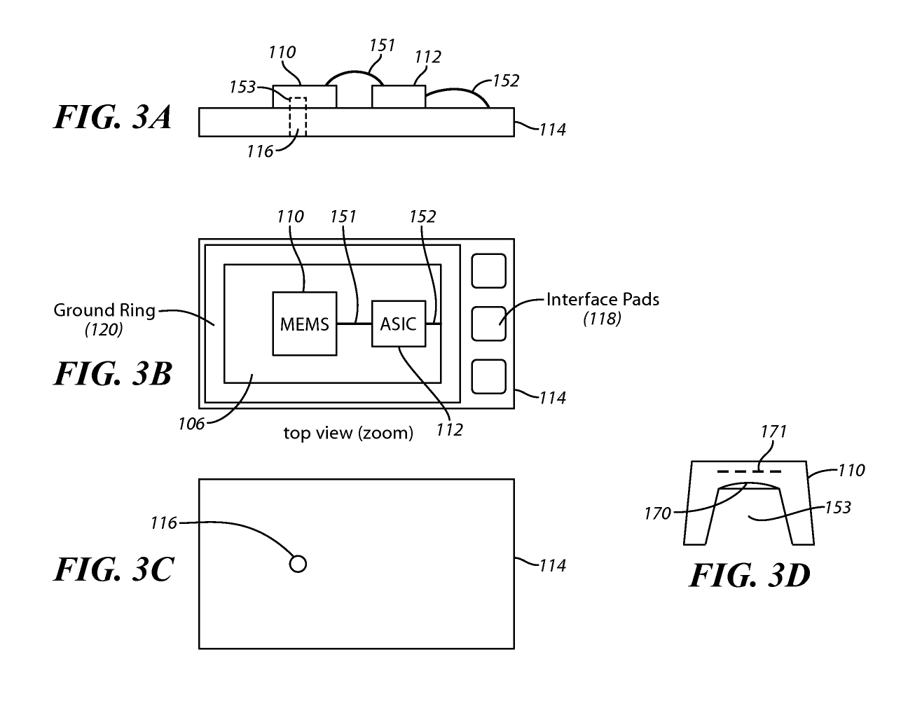

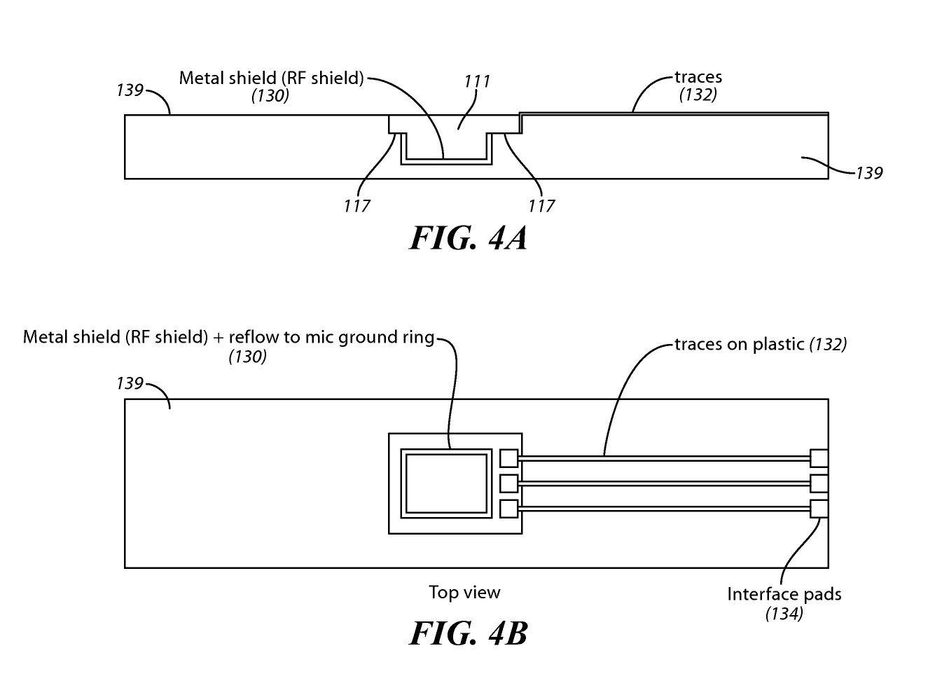

Referring now to FIG. 1, FIG. 2, FIGS. 3A-D, and FIGS. 4A-B, one example of a speaker assembly 100 is described. The speaker assembly 100 includes a housing 101. The housing 101 may be configured as a rectangular box. However, it will be appreciated that although a rectangular box shape is shown for the examples described herein, that other, non-rectangular shaped assemblies (assemblies that are circular, elliptical, or some other form or configuration) can also be used.

A MEMS microphone 106 is disposed in a cavity or pocket 111. The cavity 111 is configured so that the MEMS microphone can be laid into the cavity with the substrate of the MEMS microphone 106 pointing outward (to the exterior). In these regard, the substrate is held and supported by a ledge portion 117. In one aspect, the walls of the cavity 111 may be angled or straight depending upon the application and needs of the system.

A microphone back volume 115 is created by the MEMS microphone 106 and encompasses a portion of the cavity 111. The microphone 106 is a bottom port example and receives sound energy 121. The MEMS microphone 106 converts the sound energy 121 into an electrical signal. Conductive paths take the electrically converted sound energy from the microphone 106 and make it available to a user, for example, customer electronics associated with the device (e.g., cellular phone, personal computer) in which the assembly 100 resides.

A speaker 104 also resides within the housing 101. The housing 101 has four side walls 131, 133, 135, 137, a top wall 139, and a bottom wall 141. The housing 101 and its walls may be constructed of plastic, in one example. The cavity 111 is disposed in the top wall and can be a pocket of any suitable shape configured to hold the microphone 106 and create or form a back volume. The speaker 108 includes magnets, coils, diaphragms, and/or any other component that is used to convert an electrical signal into sound energy. Sound energy 119 is broadcast out of the speaker 104.

The speaker 104 has a back volume 108 that is configured in the interior cavity of the housing 101. In some aspects, the back volume 108 is the interior cavity. It will be appreciated that the back volume 108 (for the speaker 104) and the back volume 115 (for the microphone 106) are physically separate. In fact, the two back volumes are separated by the top 139.

Referring now especially to FIGS. 3A- 3D, the MEMS microphone 106 deployed in the speaker assembly 100 is now described. The MEMS microphone 106 includes a substrate 114. The substrate 114 may be any type of base such as a printed circuit board. Other examples of substrates are possible.

Disposed on the substrate 114 is a MEMS die 110. The MEMS die 110 includes a diaphragm 170 and a back plate 171. Sound enters the microphone 106 via a port 116, which extends through the substrate 114. In this example, a front volume 153 is formed and communicates with the port 116. The front volume 153 and the back volume 115 are separated by the diaphragm 170 and the back plate 171.

An application specific integrated circuit (ASIC) 112 is also disposed on the substrate 114. The ASIC 112 may perform various signal processing functions, to mention one example of its use. The MEMS die 110 is electrically coupled to the ASIC 112 by wires 151. The ASIC 112 is electrically coupled to the substrate 114 by wires 152.

A ground ring 120 extends around the MEMS microphone 106 and provides electrical grounding for system components. Interface pads 118 couple to traces that couple to customer electronics. The pads 118 also couple to the ASIC 112 (via traces or other conductive paths in the substrate 114).

It will be appreciated that once inserted into the cavity 111 of the housing 101, the MEMS microphone 106 may also be acoustically sealed using any appropriate sealing approach. It will also be appreciated that the MEMS microphone 106 also needs no cover or lid. In these regards and in previous approaches, the MEMS die 110 and the ASIC 112 would be enclosed by a cover to create a back volume. However, in the present approaches the cover can be dispensed with because the housing 101 (and in particular the top 139) serve to enclose the MEMS die 110 and the ASIC 112 and thereby create and form the acoustically sealed back volume 115. The non-use of a cover results in significant size savings allowing the overall assembly 100 to be reduced in size.

Referring now especially to FIG. 4A and 4B, the microphone 106 may be solder reflowed into the cavity 111 to provide electromagnetic interference (EMI) shielding and provide an interface for the signals created by the microphone 106 to reach customer electronics exterior to the assembly 100. In these regards, a metal shield 130 is disposed at the bottom surface and bottom walls of the cavity. The metal shield 130 is a Faraday cage that protects the microphone 106 from various types of interference, for example, radio frequency (RF) interference.

Conductive traces 132 are disposed on the top 139 of the assembly 100 and carry signals from the pads 118 to the pads 134. The pads 134 are coupled to external electronic circuitry, for example, external electronic circuitry in a cellular phone or a personal computer.

In one example of the operation of the assembly 100, sound 121 enters the port 116 and moves the diaphragm 170. Movement of the diaphragm 170 causes a change in the capacitance involving the back plate 171 and creates an electrical signal that is sent by wires 151 to the ASIC 112. After processing of the signal by the ASIC 112, the processed signal is sent over wires 152, which couple to pads 118 via traces on or embedded in the substrate 114. The signals then are transmitted over traces 132 to the pads 134. A customer may couple other electronic devices to the pads 134. For example, the assembly 100 may be disposed in a cellular phone or a personal computer and appropriate circuitry from these devices may be coupled to the pads.

Separately, the speaker 104 may convert electrical signals to sound energy 119. This may happen at the same times or at different times during which the microphone 106 is operating.

Consequently, the speaker assembly 100 includes the speaker back volume 108 and the microphone back volume 115, which are separated within the assembly 100, but are part of the same assembly 100. Since the speaker assembly 100 includes both the back volume 115 for the microphone 106 and the back volume 108 for the speaker 104, the overall size of the speaker-microphone assembly 100 is less than if there was no sharing of space. This results in a smaller foot print for these elements and allowing further miniaturization for systems such as cellular phones and personal computers.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. An apparatus, the apparatus comprising:
a housing;
a micro electro mechanical system (MEMS) microphone disposed within the housing, the MEMS microphone having a first diaphragm that separates a first front volume from a first back volume, the MEMS microphone configured to receive first sound energy at the first front volume and convert the first sound energy into a first electrical signal, the first back volume contained within the housing;
a speaker disposed within the housing, the speaker having a second diaphragm that separates a second front volume from a second back volume, the speaker configured to receive a second electrical signal and convert the second electrical signal into second sound energy, the second back volume being contained within the housing;
such that the first back volume and the second back volume are separated by a divider and do not overlap.

2. The apparatus of claim 1, wherein the MEMS microphone and speaker are configured to operate at the same time.

3. The apparatus of claim 1, wherein the MEMS microphone and speaker are configured to operate at different times.

4. The apparatus of claim 1, further comprising an electromagnetic shield.

5. The apparatus of claim 1, further comprising an integrated circuit coupled to the MEMS microphone.

6. The apparatus of claim 1, further comprising an electrical conductive path coupled to the MEMS and electrical pads coupled to the conductive path.

7. The apparatus of claim 1, wherein a customer electronic device is coupled to the pads.

8. The apparatus of claim 7, wherein the customer electronic device is associated with a cellular phone, a lap top computer, a tablet, or a hearing aid.
